(19) United States
(12) Patent Application Publication
(10) Pub. No.: US 2006/0143562 A1
(43) Pub. Date: Jun. 29, 2006

(54) Self-describing editors for browser-based WYSIWYG XML/HTML editors

(76) Inventors: Andreas Seurig, Rottenburg (DE); Thomas Spillecke, Stuttgart (DE)

Correspondence Address: IBM CORPORATION;INTELLECTUAL PROPERTY LAW, 11400 BURNET ROAD, AUSTIN, TX, 78758, US

(21) Appl. No.: 11/315,381

(22) Filed: Dec. 21, 2005

(30) Foreign Application Priority Data
Dec. 29, 2004 (EP) 04107047.5

(51) Int. Cl. G06F 17/21; G06F 3/00

(52) U.S. Cl. 715/513; 715/700

(57) ABSTRACT

A method and system for editing arbitrary XML formatted web content within a graphical user interface (GUI), where user-edited XML is converted according to the rules of a XSL style sheet using a XSLT Processor into a mark-up document specific to the browser software running on a client side operating system. Since XML is not very human friendly readable or editable, the XML based web content needs to be converted in a web-mark-up that is better readable and therefore modifiable. The editing process takes place within the browser that displays the rendered XML content.

### 1. BACKGROUND OF THE INVENTION

1.1 Field of the Invention

The present invention relates to the technology of web computing, and in particular to a method and respective system for editing arbitrary XML formatted web content within a graphical user interface (GUI), wherein user-edited XML is converted via a XSLT Processor component into a web browser specific mark-up document.

1.2 Description and Disadvantages of Prior Art

Prior art web content creation bases widely on HTML-editing. With the need to support multiple access devices (desktop, PDA, cellphones etc.) web content is preferable stored as XML only. The different mark-up languages for the different devices and browsers are generated by XSLT conversion. The conversion script is represented in so-called XSL-style sheets. Corporate identity style elements can easily be expressed by using cascading style sheets (CSS) in addition. Using these three types of document specifications, namely XSL, XML and CSS, which is converted to be displayed on different client devices, results in a strict separation of content and design. XML is storing the pure content information, whereas XSL and CSS define the presentation of the content.

However, the creation of XML content is not very easy, since the information is stored in-between user specified tags, which are not human-friendly readable and mostly unknown to prospective content consumers. Editing XML is simplified with the help of WYSIWYG editors, which remind the user of well-known word processors, but not completely imitate their functionality or behavior.

A common scenario is information representation in organizations. Business environments often use different document templates to format uniquely information, like top news, articles, memorandums, etc. Each document template requires parameters to define the layout and design. The final view is affected by style sheets (XSL, CSS).

In this prior art web editing, the common situation is that the editing user will create XML content in a web browser. Therefore, XML/HTML conversion and CSS technologies are focused by the present invention.

A prior art browser-based WYSIWYG XML/HTML Editor is publicly available by (www.xopus.com). It supports different XML formats.

The prior art system view for browser-based web editing is depicted in FIG. 1.

A user runs a HTML web browser. An XML document 10 containing content is due to be changed. The XML content is verified against an XSD file 12, where the XOPUS program checks, if the specific XML dialect can be processed by the XOPUS editor workbench. If the check is successful and known elements (tag names and structure) are found in the source document it is forwarded. A XSLT Processor 16 converts the XML into a web browser optimised HTML output 19 using an XSL style sheet 18. In a web page the user is presented with said XML document.

With reference to the focus of the invention the prior art web editor system of XOPUS has one base implementation of a generic element editor (e.g. image, table editor) supporting different XML formats only if the specific structure of the XML format (the dialect) is made known to XOPUS using the XSD schema file. Therefore XOPUS supports known elements contained in an XML file. Elements usually follow a standard, this could be a general international standard or a agreement on corporate identity. Once defined the user has several degrees of freedom when editing a document, but all documents, regardless of template type use the same specifically adopted editor. This is usually a drawback in a restrictive environment since every change to a specific template results in a major change in the structure of the editor. The editor is limited in the amount of reusable, adaptable objects. A more sophisticated framework is necessary to fulfil the need for a restrictive environment, which enables the user to create XML content.

However, depending on the skill of the user or on the type of (XML) document the restrictions are more or less narrowed. For example, an image may have the attributes size, position, capture, source, creator, text flow etc. Different image editors must then be provided in order to support the different attributes. In regard of the various XML-document-standards and respective various XML-element-editors that support different levels of attribute-editing, a huge amount of XML-element-editors are required. Furthermore, there are dependencies on CSS and XSL files 18. This results in an editor environment which is too complex to handle for an editing user, and too hard to keep up-to-date for a vendor of editor software.

### 1.3 OBJECTIVES OF THE INVENTION

It is thus an objective of the present invention to provide a more flexible alternative to edit XML web content within a web portal by aid of a web browser displaying e.g. HTML or the like.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

The core idea of the present invention is to use XML editor packages. They provide the necessary information, like style sheets, i.e., suggestions for xsl and css, national language files, icons and documentation.

When documents are being edited, schemas, additional style sheets and the respective element editors have to be provided. The present invention simplifies the editing procedure of documents, and further more facilitates the creation of document templates. Therefore the aggregation process of components to define a document template is accelerated and clearly defined.

This creation process is oriented on the intension of XML, that a user should be limited to content creation. The enterprise-specific styles and layouts are automatically applied to the created content.

By that the basic advantage of the present invention is achieved to provide a comfortable method for graphically editing web content without requiring XML code knowledge from the editing user.

In more detail, the present invention discloses the approach to design a framework which is capable of editing any kind of XML format. This flexibility is reached by the invention by using this framework and adopting so-called “Content Builders” to automatically match the desired individual XML format.

Further advantageously, by using documented interfaces and an object-oriented approach, new Content Builders can be easily written. They provide the functionality to modify XML elements within predefined, programmed boundaries.

In addition different XML elements may require different ways of editing, for example in-place text editing, direct input of various attributes or graphical manipulation of objects. This variability is also covered by the inventional disclosure.

XML is a layout-neutral format, which represents a code for processing pure content information, i.e., text or number-based information. An editing person edits in HTML, but—fully transparent to the user—edits XML code by virtue of the inventional method. When the graphical editing actions input by the user are completed, then XML code is automatically generated, and this XML code is converted by a XSL-processor into HTML code, wherein the display-specific rules are given in an accompanying XSL code. The editing user is presented with a HTML-based presentation and user interface in the browser and may edit web content without XML knowledge.

According to a basic aspect of the invention a method and system for editing web content within a graphical user interface (GUI) is disclosed, wherein a content-describing code like XML is converted via a converter component—preferably a XSLT Processor—into the browser specific mark-up comprising document which is displayed based on executing said exemplarily mentioned HTML document within a web browser,

wherein said method is characterized by

a) detecting a predetermined event triggered by respective graphical user interface (GUI) actions done by a user when editing a predetermined editable element in a predetermined browser-displayable format,

b) handling said event by looking up a predefined corresponding Content Builder component mapped to said editable element for being selected for executing the edit actions of the user,

c) invoking the selected Content Builder component offering to the user a defined set of GUI edit options specific for said editable element,

d) converting edit-actions of the user within the offered options into a respective updated browser document in said browser-displayable format adapting XML fragments implementing said edit actions done by the user,

e) visualizing said XML document by aid of said browser-displayable format.

In order to uniquely associate a given XML fragment with a corresponding HTML fragment, the present invention proposes to implement IDs for the XML fragments and respective IDs for the HTML fragments. A set of mapping rules provides for a unique association between XML and HTML fragments. This mapping is unique from XML to HTML.

Every element in the XML file is associated to a specific Content Builder, which provides the necessary functionality to modify the current element. Said unique mapping ensures that every XML document can be edited using the respective useful Content Builder. This is a reason for the high flexibility and extensibility of the inventional method. For HTML web browser the mapping and HTML-to-XML conversion is implemented preferably in JavaScript syntax, whereas the originating IDs for the mapping are converted from the XML elements into the HTML elements using the XSL file (XSLT conversion).

Further, advantageously, said set of mapping rules is individually defined for each particular document type.

Thus, the advantage results that any document type having diverse shape and/or style constraints can be comfortably edited without XML knowledge being required for the editing user.

According to a preferred feature of the present invention the editing person shall not be allowed to have a total freedom of editing. Instead the editing user should be “guided” by the inventional editor framework within some useful editing limits, which are specific for each document type. In this way, even a web editing strategy compliant to a precisely given set of rules, for example as defined by corporate identity requirements of an enterprise can be achieved easily, for instance by allowing only the color “of the enterprise”, when adding a word at a topmost, highly exposed location in a web site. Further, due to a scalable guidance of the editing persons, which may be achieved by a respective desired design of the inventional Content Builder components, web editing can be consistently done even by a plurality of different people without too much manual revisions.

### 3. BRIEF DESCRIPTION OF THE DRAWINGS

The present invention is illustrated by way of example and is not limited by the shape of the figures of the drawings in which:

FIG. 1 is a prior art schematic system view illustrating the essential components for prior art browser-based web content editing,

FIG. 2 is a schematic system view illustrating the essential components for browser-based web content editing according to a preferred embodiment of the present invention,

FIG. 3 is a schematic view to the interfaces between framework manager 24 and the GUI presented to the user, and a Content Builder library according a preferred embodiment of the present invention.

FIG. 4 is a schematic diagram illustrating the mapping between XML and HTML exemplarily with a Paragraph Content Builder.

FIG. 5 is a schematic diagram illustrating the mapping between XML and HTML exemplarily with a more complex headline Content Builder, and

FIG. 6 is a schematic diagram illustrating single steps, when a preferred embodiment of the inventional method is performed by an editing user.

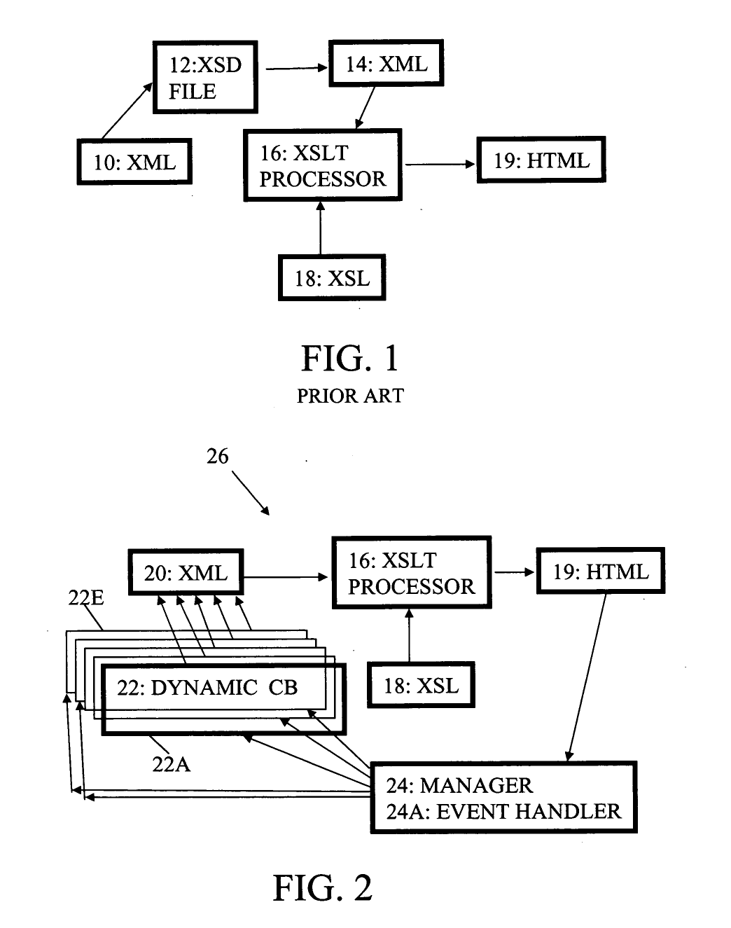

### 4. DETAILED DESCRIPTION OF THE PREFERRED EMBODIMENT

With general reference to the figures and with special reference now to FIG. 2 the Content Builder components 22A . . . E enable the user to modify and change elements in the HTML view 19 and convert these changes back to XML 20. As a result the content of the XML document 20 is modified. The Content Builder Components 22 are connected to Events by an Event handler component 24 A implemented within the framework manager 24, and to the Visualization Components, i.e., a XSL-file 18 and an XSLT processor 16 (both prior art), required for generating HTML output 19. User-initiated events force the Content Builders 22 to react according to the user's interest. Possible actions to be executed by the Content Builder are presented to the user by means of said Visualization Components.

In an example, the XML source document 20 contains the content information in standard NITF format. The XSL style sheet converts the elements of the NITF document into HTML output 19 by aid of the XSLT processor 16. A simple scenario is the presentation of a NITF paragraph, which is converted into an HTML paragraph.

<?XML version=“1.0”?>
<!DOCTYPE nitf SYSTEM “ . . /dtd/nitf-3-2.dtd”>
<nitf> ...
<p ID =“p_1”>This is a sample paragraph containing some text. It
is taken from a nitf document.</p>
... </nitf>

The same paragraph in an HTML document [W3C HTML, 1999] may look similar to the XML version.

<HTML>
<head> <title> HTML output </title>
<link ref=“format CSS”>
</head>
<body> ...
<p ID =“p_1” class=“style_p”>This is a sample paragraph
containing some text. It is taken from a nitf document.</p>
... </body>

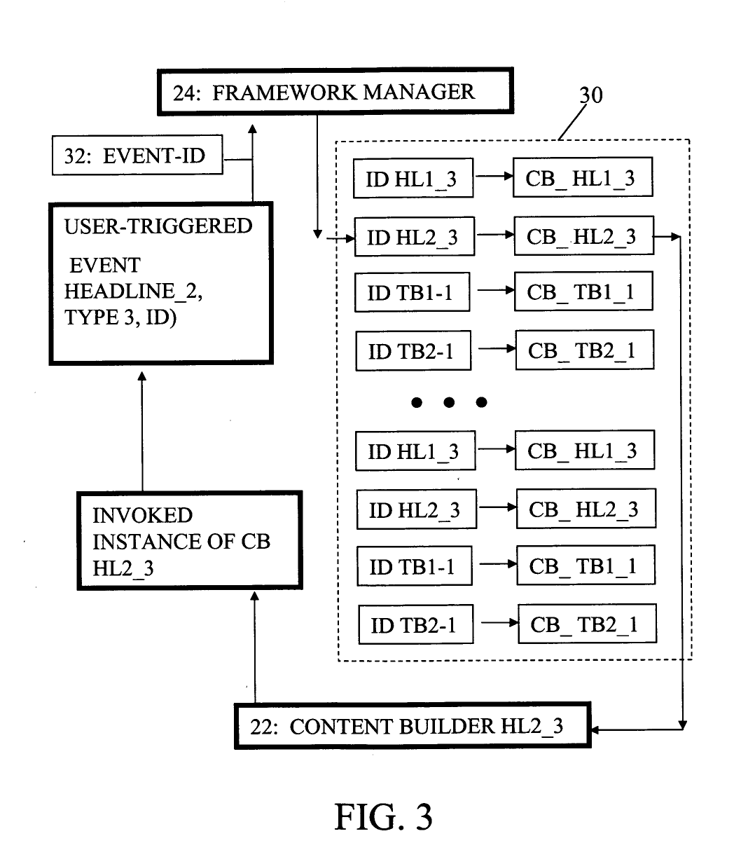

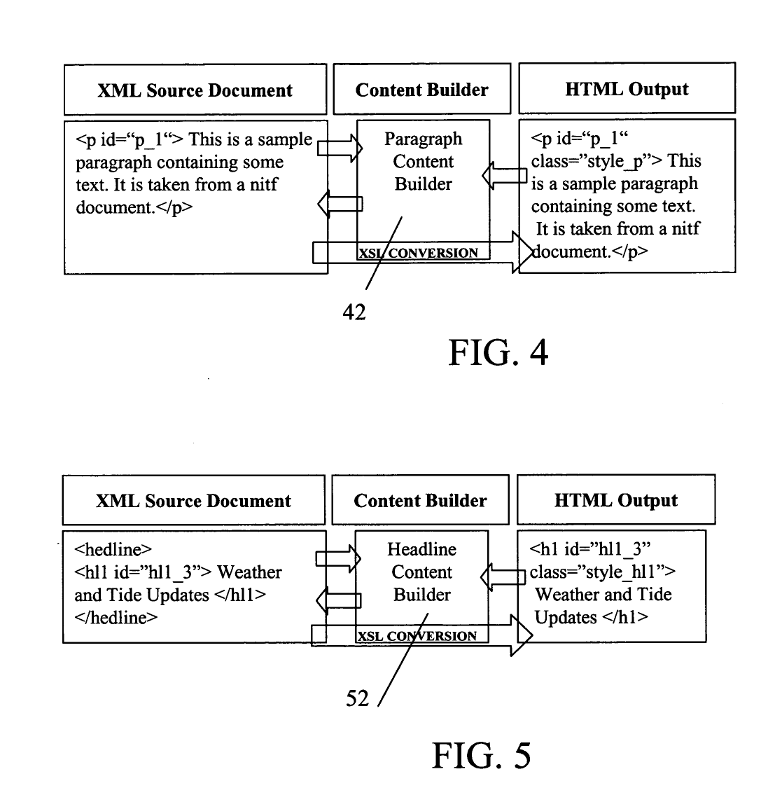

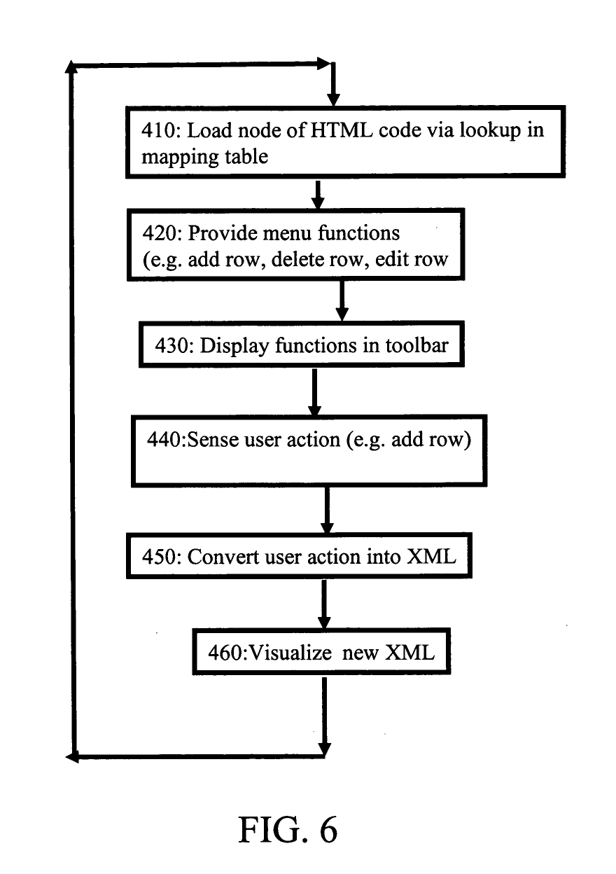

With additional reference to FIGS. 4, 5 and 6, XML and HTML fragments, which uniquely correspond to each other are identified using a consequent ID mapping, see also FIG. 3, where ID 32 is marked, when the editing user clicks the headline field identified by ID “HL_{—}2_{—}3”. Then in step 410 (FIG. 6) the node of the HTML code is loaded which has the same ID. Such mapping is strictly required. This is achieved via a respective look-up in a storage structure 30, which may be simply implemented as a mapping table. Each XML element has a unique ID which is kept constant and is assigned to the converted HTML output. If the paragraph in the HTML format is selected, the unique ID is used to find the according element in the XML source document. The user can edit the text in the HTML view. The Paragraph Content Builder 42, provides the particular menu functions, see step 420, displays respective particular functions in a toolbar, step 430, and resolves the user-modified HTML DOM node and converts its structure into XML, steps 440, 450. The original text of the paragraph in the XML source document is deleted and replaced by new text. This behaviour is illustrated by the broad arrows in FIG. 4. Afterwards the XML document is re-rendered, see step 460 in FIG. 5 by XSL conversion according to W3C XSLT, 1999, to produce a respective new HTML output which comprises the edit changes just done before.

With further reference to FIG. 5, a more complex headline Content Builder mapping is illustrated. This is required due to the fact that the structures in XML sources can get more complicated. For example headlines have a nested structure, which is not equal to the structure in the HTML output. Headlines of order one (hl1) in NITF documents are always enclosed by the “hedline” tag. Headlines of order two (hl2) could occur in different places outside the “hedline” tag, but only once within it. An example is given as follows:

<?XML version=“1.0”?>
<!DOCTYPE nitf SYSTEM “. . /dtd/nitf-3-2.dtd”>
<nitf> ...
<hedline id=“hedline_2”>

<hl1 id=“hl1_3”>Weather and Tide Updates</hl1>
<hl2 id=“hl2_4”>A sample, fictitious NITF article</hl2>

</hedline>
... </nitf>

The XSLT allows the conversion from XML elements into any other element. In FIG. 5 the NITF headlines are converted into HTML headlines. The HTML standard specifies several orders of headlines, numbered from 1 (highest) to 6 (lowest), e.g. h1 to h6 (compare the W3C recommendation [W3C HTML, 1999]). Another variation to be encountered may be the conversion from hl1 into a link to present a link list. But HTML does not provide a “hedline” tag used in the NITF document. Then, this structure is lost after the conversion into HTML.

<HTML>
<head> <title>HTML output</title>
<link ref=“format CSS”>
</head>
<body> ...
<h1 id=“hl1_3” class=“style_hl1“>Weather and Tide Updates</h1>
<h2 id=“hl2_4” class=“style_hl2”>A sample, fictitious NITF
article</h2>
... </body>

If the ID is selected in the HTML output, the corresponding ID is matched in the XML document. Now the “black box”, the Headline Content Builder 52 has a much more intensive task. The specific position of the headline hl1 and the corresponding parent element “hedline” has to be found. Therefore the Content Builder contains more logic to track its position. This achieved as follows:

The Content Builder retrieves the node to be edited. In case of the hedline editor only the “hl1” element is mapped to an ID. Since XML uses a tree structure to store content, containing descendants, ancestors and siblings. The logic inside the Content Builder has to check the parent of the current element and retrieve its position. If necessary the “hedline” element found has to be modified as well. This is a fairly simple example. NITF provides “media” elements, i.e. images, sounds, flash movies that use a more complicated nested structure. If this structure is completely refactored during the XSL Processor conversion process, the logic has to know about this structure and check the surrounding elements as well.

Another valuable feature of the present invention is the creation of a new headline. If the document allows inserting a new hl1 headline into the document, a respective “hedline” element has to be created as well. If the “hedline” tag contains not only hl1 but also hl2 the deletion of hl1 is not simply possible. The “hedline” must not be empty and can not contain only a headline of order 2 (hl2). The NITF specification specifies this structure. Then, according to this preferred implementation of the inventional method the Content Builder 52 has two choices:
1. Remove the whole “hedline” element together with the nested hl1 and hl2
2.Prompt the user to confirm the deletion of hl2 element

According to a preferred feature of the present invention a strict separation of content and design is accomplished when solving such headline problems.

Cascading Style Sheets (CSS), see W3C CSS, 1999, are essential to achieve said separation. All fonts, colors and borders are defined in an external style sheet, e.g. “format.CSS”. Styles in the CSS files can be assigned to specific classes. The class attribute inside the HTML tag maps the style to this tag, e.g. class=“style_hl1”.

As can be seen in the examples given above, every XML element is associated with a Content Builder. According to a preferred feature of the invention the mapping of a Content Builder to an element (XML/HTML) is specific to every document type.

In this case it is recommended to build a double-index, one part encoding the document type, and the other the specific XML element, or fragment, respectively. With reference to FIG. 3 above the selected ID “HL2_{—}3” currently encodes the XML element “headline style 2” and identifies the object as unique, indexed as number 3. The document type could be appended to this ID, i.e. “HL2_{—}3_TopNewsArticle”.

A document-type specific Content Builder selection is recommended, as an image in a news article needs to be edited differently than an image in a technical article. A configuration section using a JavaScript array explicitly maps the XML element and the constructor of the Content Builder. This mapping is stored on the server side framework. If an XML document is requested to modify content, the specific Content Builders and mappings are combined and are sent to the client side framework to be executed inside the web browser, as follows exemplarily:
var elementMapping=new Array( );
elementMapping [“p”]=“p_content builder”;
elementMapping [“media”]=“image_content builder”;
elementMapping [“a”]=“link1_content builder”;

Also, new Content Builders can easily be created by implementing the necessary interfaces. In total, three interfaces are defined to implement additional Content Builders. The interfaces group the methods comprising the functionality belonging to one set or scope of functions:

a) Editor Life Cycle (EditorLC)

b) Transform Selection (TransformSelection)

c) Nested Node Identification (SubNodeResolution)

These methods are used by the surrounding framework to provide the functionality to the user or to provide other components inside the framework.

The Editor Life Cycle provides the methods to
start/stop a Content Builder,
load the node to be edited,
create new (empty) nodes to be inserted into the document,
provide menu functions, which are displayed either in the toolbar or the context menu,
find the according style of the node contained in the Cascading Style Sheet;

The Transform Selection provides the methods to change content of the currently selected node into new elements. The behaviour is described using an example:

If a paragraph contains a lot of new information in text-based form, the editing user wants to highlight some words. The selected words are then surrounded by new tag elements, i.e. the emphasize elements “<em>highlight words</em>”, or additional other pages are linked to the current document by transforming words into clickable links, i.e. “<a href=‘new_page.XML’>New page</a>”.

Nested Node Identification is necessary since the structure of XML documents consists of nested elements. The Content Builder is specific to its XML element. The Structures of XML allows the nesting of different elements beneath each other. A single Content Builder cannot contain every possible combination of elements and therefore poses a request to the framework if an unknown child node is found within the current element. The methods contained in this interface allow resolving such issues from another Content Builder by returning a resolved node, ready to be inserted.

All methods used in these three interfaces take specific parameters and return data in specific formats, not mentioned explicitly.

The inventional method can be advantageously used for generating specific Content Builders.

A specific table editor is provided by displaying a table structure to the user presenting input fields, which are pre-arranged in a table form, wherein the style of different table types are selectable.

Further, a specific calendar Content Builder is easily provided by the inventional method by extending the constraints of such table to calendar-specific constraints. For example, a month-table comprises not more than five week columns, wherein a week column comprises seven rows for representing the days of a week. Then the month columns are named and subjected to a calendar-specific constraint delimiting the month of February for instance to 28. In addition the exact year is prompted from the user and a calculation determines, if the month of February holds 28 or 29 days. Similar constraints are implemented for the other months in a year. This generates the specific Layout of a Calendar, which is referred to herein as Calendar Content Builder.

Other examples for useful, specific Content Builders (CB) are as follows:

An inline Content Builder restricts the user to input in a given line, paragraph, title, or headline;

a menu driven Content Builder implements the functions delete, add, list, emphasize of elements;

a list Content Builder generates a list of editable elements;

a link Content Builder generates a link to a given element;

an image Content Builder implements functions like zoom-in, zoom-out, turn, reduce to black/white display,

a wizard-driven Content Builder enables Content Builders to prompt the user for specific information, i.e. the rows and columns of a table. Since this a pre-delivered component of the framework, Content Builders can use this component if they have to prompt information from the user. This mechanism is used to provide a unique “look & feel” implementation of the XML editor and reduces the programming effort for new Content Builders.

Those and other Content Builders which can be easily added by a person skilled in the art are provided within the inventional editor framework.

It should be noted that the disclosure of the present invention is also applicable to content-describing document languages other than XML.

The present invention can be realized in hardware, software, or a combination of hardware and software. An editor tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following:

a) conversion to another language, code or notation;

b) reproduction in a different material form.

1. A method for editing web content in a web browser within a graphical user interface (GUI), wherein a content-describing code is converted via a converter component into a browser-displayable format,
characterized by the steps of:
a) detecting a predetermined event triggered by respective graphical user interface (GUI) actions done by a user when editing a predetermined editable element in a predetermined browser-displayable format,
b) handling said event by looking up a predefined corresponding Content Builder component mapped to said editable element for being selected for executing the edit actions of the user,
c) invoking the selected Content Builder component offering to the user a defined set of GUI edit options specific for said editable element,
d) converting edit-actions of the user within the offered options into a respective updated browser document in said browser-displayable format adapting XML fragments implementing said edit actions done by the user,
e) visualizing said XML document by aid of said browser-displayable format.

2. The method according to claim 1, wherein said browser-displayable format is HTML or WML.

3. The method according to claim 1, wherein the mapping between editable element and Content Builder component is document type specific.

4. The method according to claim 1, wherein one or more of the following specific Content Builders (CB) are provided:
a) an inline Content Builder,
b) a table Content Builder,
c) a calendar Content Builder,
d) a menu driven Content Builder,
e) a list Content Builder,
f) a link Content Builder,
g) an image Content Builder.

5. The method according to the preceding claim, wherein a Content Builder component is wizard-driven.

6. The method according to claim 1, wherein the GUI edit options offered to the user are limited according to predetermined rules.

7. The method according to claim 1, wherein a Content Builder is self-describing by further comprising the steps of:
a) offering edit functions of a predetermined subset of Content Builders,
b) prompting the user to select one or more of said offered functions,
c) automatically deploying a new Content Builder by inclusion of the user-selected functions.

8. A computer system for editing web content in a web browser within a graphical user interface (GUI), wherein a content-describing code is converted via a converter component into a browser-displayable format,
said computer system comprising:
a) an event handler component for:
a1) detecting a predetermined event triggered by respective graphical user interface (GUI) actions done by a user when editing a predetermined editable element in a predetermined browser-displayable format,
a2) handling said event by
a22) looking up (a predefined corresponding Content Builder component for being selected for executing the edit actions of the user, and
b) a framework manager for:
b1) mapping a predefined respective Content Builder component to an editable element,
b2) invoking the selected Content Builder component offering to the user a defined set of GUI edit options specific for said editable element,
b3) converting edit-actions of the user within the offered options into a respective updated browser document in said browser-displayable format adapting XML fragments implementing said edit actions done by the user,
b4) visualizing said XML document by aid of said browser-displayable format.

9. A computer program for execution in a data processing system for editing web content in a web browser within a graphical user interface (GUI), wherein a content-describing code is converted via a converter component into a browser-displayable format,
comprising a functional component for:
a) detecting a predetermined event triggered by respective graphical user interface (GUI) actions done by a user when editing a predetermined editable element in a predetermined browser-displayable format,
b) handling said event by looking up a predefined corresponding Content Builder component mapped to said editable element for being selected for executing the edit actions of the user,
c) invoking the selected Content Builder component offering to the user a defined set of GUI edit options specific for said editable element,
d) converting edit-actions of the user within the offered options into a respective updated browser document in said browser-displayable format adapting XML fragments implementing said edit actions done by the user,
e) visualizing said XML document by aid of said browser-displayable format.

10. A computer program product stored on a computer usable medium comprising computer readable program means for causing a computer to execute in a data processing system a program implementation for editing web content in a web browser within a graphical user interface (GUI), wherein a content-describing code is converted via a converter component into a browser-displayable format,
comprising a functional component for:
a) detecting a predetermined event triggered by respective graphical user interface (GUI) actions done by a user when editing a predetermined editable element in a predetermined browser-displayable format,
b) handling said event by looking up a predefined corresponding Content Builder component mapped to said editable element for being selected for executing the edit actions of the user,
c) invoking the selected Content Builder component offering to the user a defined set of GUI edit options specific for said editable element,
d) converting edit-actions of the user within the offered options into a respective updated browser document in said browser-displayable format adapting XML fragments implementing said edit actions done by the user,
e) visualizing said XML document by aid of said browser-displayable format.
